(19) United States
(12) Patent Application Publication
(10) Pub. No.: US 2012/0069458 A1
(43) Pub. Date: Mar. 22, 2012

(54) ROTATION ASSIST ASSEMBLY

(75) Inventors: Kisaburo KUROBE, Osaka (JP); Jiro Muratsu, Osaka (JP); Hidemitsu Suyama, Osaka (JP)

(73) Assignee: Panasonic Corporation, Osaka (JP)

(21) Appl. No.: 13/023,541

(22) Filed: Feb. 9, 2011

(30) Foreign Application Priority Data
Sep. 17, 2010 (JP) 2010-209448

(51) Int. Cl. G02B 7/02

(52) U.S. Cl. 359/822

(57) ABSTRACT

A rotation assist assembly is an assembly for assisting the rotation of a rotary adjustment member included in a lens barrel, and includes a base portion and a grip portion. The base portion is configured to be wound around the rotary adjustment member along a rotation direction of the rotary adjustment member. The grip portion is coupled to the base portion in the rotation direction, and a user's finger is placed on this grip portion when rotating the rotary adjustment member. A first maximum dimension from a rotational center of the rotary adjustment member to an outer face of the grip portion in a radial direction of the rotary adjustment member is greater than a second maximum dimension from the rotational center to a radial outer face of the base portion.

### CROSS-REFERENCE TO RELATED APPLICATIONS

This application claims priority under 35 U.S.C. §119 to Japanese Patent Application No. 2010-209448, filed on Sep. 17, 2010. The entire disclosures of Japanese Patent Applications No. 2010-209448 is hereby incorporated herein by reference.

### BACKGROUND

1. Technical Field

The technology disclosed herein relates to a rotation assist assembly. More specifically, the technology disclosed herein relates to a rotation assist assembly that assists rotation of a rotary adjustment member included in a lens barrel.

2. Background Information

The lens barrel of an imaging device has a zoom ring, focus ring, and other such rotary adjustment members. The user can turn the zoom ring to adjust the focal length (image angle) of the optical system and can turn the focus ring to adjust the imaging distance (the distance from the main subject to the imaging device).

However, these rotary adjustment members come in many different sizes and require varying amounts of force to operate, and users' hands of course also come in all different sizes. Therefore, there may be many users who feel that the rotary adjustment member is difficult to operate when they turn the rotary adjustment member.

In view of this, there has been proposed an assist device for assisting the rotary operation of a rotary adjustment member (see, for example, Utility Model JP-3,160,546).

With the assist device discussed in Utility Model JP-3,160,546, however, since the outside diameter of the ring member is constant, it is conceivable that a user may find rotary operation difficult.

### SUMMARY

A rotation assist assembly disclosed herein is an assembly for assisting the rotation of a rotary adjustment member included in a lens barrel, and comprises a base portion and a grip portion. The base portion is configured to be wound around the rotary adjustment member along a rotation direction of the rotary adjustment member. The grip portion is coupled to the base portion in the rotation direction, and a user's finger is placed on this grip portion when rotating the rotary adjustment member. A first maximum dimension from a rotational center of the rotary adjustment member to an outer face of the grip portion in a radial direction of the rotary adjustment member is greater than a second maximum dimension from the rotational center to a radial outer face of the base portion.

These and other features, aspects and advantages of the technology disclosed herein will become apparent to those skilled in the art from the following detailed description, which, taken in conjunction with the annexed drawings, discloses a embodiments of the invention.

### BRIEF DESCRIPTION OF DRAWINGS

Referring now to the attached drawings which form a part of this original disclosure:

FIG. 1A is an oblique view of a digital camera to which a rotation assist assembly is mounted, and FIG. 1B is an oblique view of a digital camera;

FIG. 2A is a plan view of a rotation assist assembly (mounted state), and FIG. 2B is a plan view of a grip belt;

FIG. 3A is a plan view of a rotation assist assembly (unmounted state), and FIG. 3B is a plan view of a rotation assist assembly (unmounted state);

FIG. 4A is an oblique view of a grip belt, and FIG. 4B is an oblique view of a grip belt;

FIG. 5 is an oblique view of a grip belt;

FIG. 6 is an enlarged plan view of a first grip portion;

FIG. 7 is a cross section along the VII-VII line in FIG. 6;

FIG. 8A is an enlarged plan view of a second grip portion, and FIG. 8B is an enlarged plan view of a third grip portion;

FIG. 9A is a cross section along the IXA-IXA line in FIG. 9B, and FIG. 9B is a plan view of a fixing belt; and

FIG. 10 is an enlarged plan view of a grip portion (other embodiment).

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

Configuration of Digital Camera

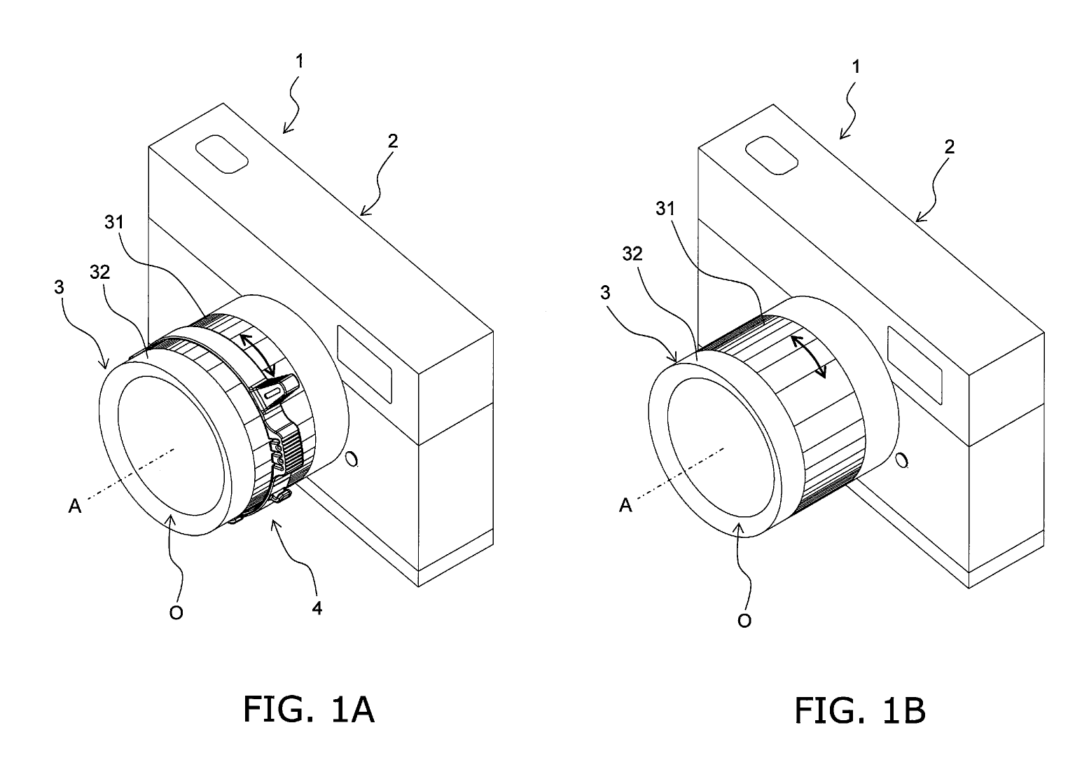

A digital camera 1 is an imaging device capable of acquiring image data about a subject and is an interchangeable type of digital camera. As shown in FIGS. 1A and 1B, the digital camera 1 has a camera body 2 and an interchangeable lens unit 3.

The interchangeable lens unit 3 (one example of a lens barrel) has a barrel 32 and a zoom ring 31 (an example of a rotary adjustment member). The zoom ring 31 is rotatably supported by the barrel 32. The focal length (image angle) of an optical system O can be adjusted by turning the zoom ring 31.

The rotational direction of the zoom ring 31 shall be termed the “rotation direction” (an example of the rotation direction of the rotary adjustment member). The rotation direction substantially coincides with the direction in which a rotation assist assembly 4 is turned and with the circumferential direction of the rotation assist assembly 4. The radial direction of the zoom ring 31 (a direction perpendicular to the optical axis A) shall be termed the “radial direction” (an example of the radial direction of the rotary adjustment member). The radial direction substantially coincides with the radial direction of the rotation assist assembly 4. Further, a direction parallel to the optical axis A of the optical system O shall be termed the “optical axis direction” and “width direction” (an example of a width direction perpendicular to the radial direction and the rotation direction). In the following description, the directions explained above will be used to describe the configuration of the various components of the rotation assist assembly 4.

Since the rotational center of the zoom ring 31 is disposed along the optical axis A, in the following description the rotational center of the zoom ring 31 shall also be called the rotational center A.

Rotation Assist Assembly

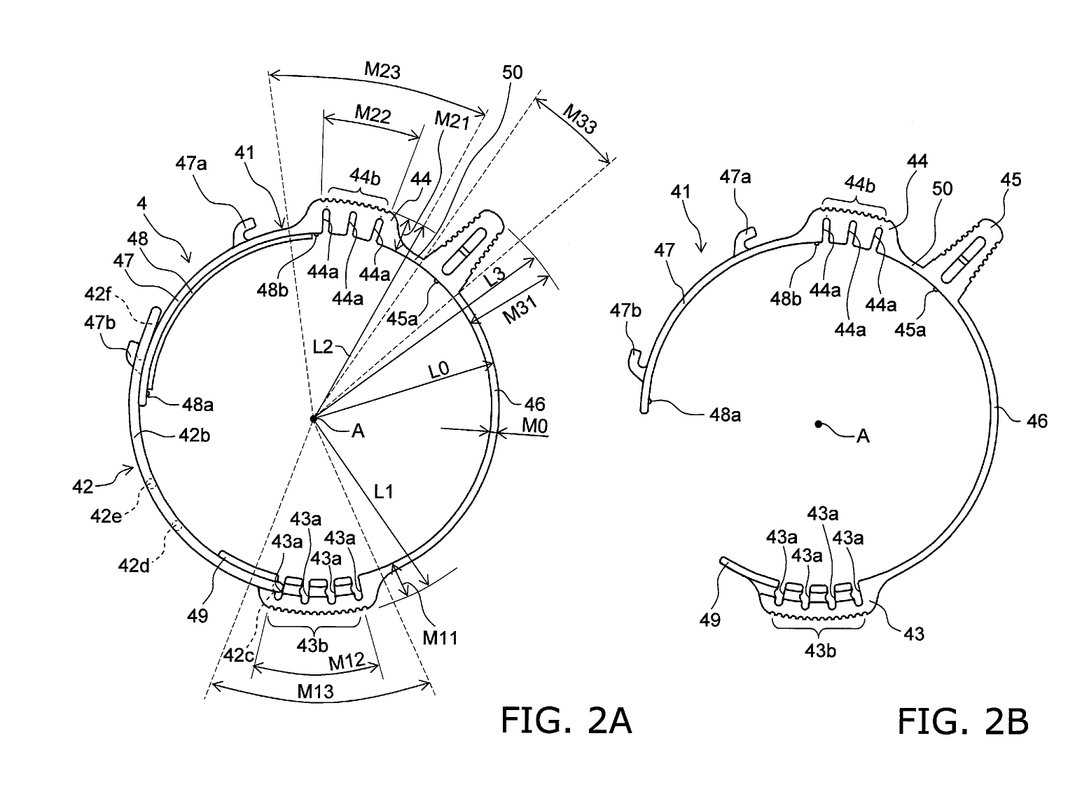

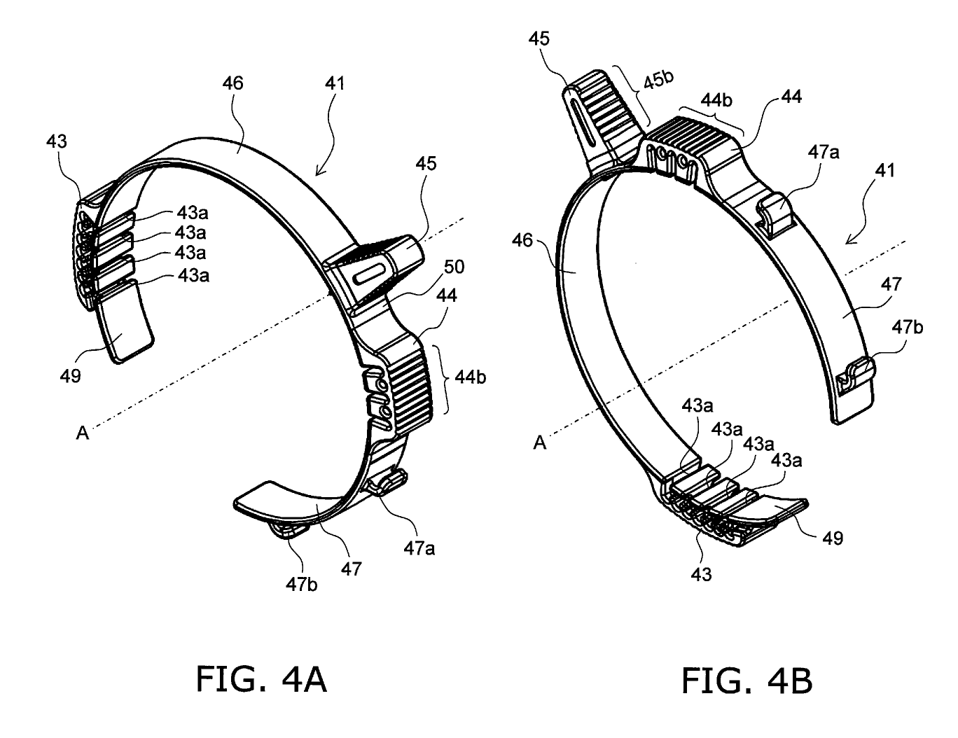

The rotation assist assembly 4 is a member that assists the user to rotate the zoom ring 31 and can be mounted on the outer peripheral side of the zoom ring 31. As shown in FIGS. 2A to 5, the rotation assist assembly 4 comprises a grip belt 41, a fixing belt 42, and felt 48.

Grip Belt

The grip belt 41 is a substantially belt-shaped member and is entirely and integrally formed from resin, for example. The grip belt 41 substantially has a C shape so as to make it easier to mount to the zoom ring 31. Since the length of the grip belt 41 is set considerably shorter than the outer periphery of an ordinary rotary adjustment member, the ends of the grip belt 41 do not touch each other when the grip belt 41 is mounted to the rotary adjustment member. In mounting the rotation assist assembly 4 to the zoom ring 31, the ends of the grip belt 41 are linked by the fixing belt 42 (discussed below). The grip belt 41 has a first base portion 46, a second base portion 47, a third base portion 50, a fourth base portion 49, a first grip portion 43, a second grip portion 44, a third grip portion 45, and a rotation restricting protrusion 45a.

(1) First Base Portion 46

The first base portion 46 (one example of a base portion, and an example of part of a base portion) is a belt-shaped portion that is wound around the zoom ring 31 in the rotation direction of the zoom ring 31 (the rotation direction of the rotary adjustment member). The first base portion 46 is relatively long compared to the other base portions (the second base portion 47, the third base portion 50, and the fourth base portion 49), and is disposed between the first grip portion 43 and the third grip portion 45.

(2) Second Base Portion 47

The second base portion 47 (one example of a base portion) is a belt-shaped portion that is wound around the zoom ring 31 in the rotation direction of the zoom ring 31 (the rotation direction of the rotary adjustment member) and is linked to the second grip portion 44 in the rotation direction. The second base portion 47 protrudes in the rotation direction from the second grip portion 44 and forms a first end of the grip belt 41.

The second base portion 47 has stoppers 47a and 47b disposed spaced apart in the rotation direction. The stoppers 47a and 47b (an example of stoppers) are provided to catch the fixing belt 42 and protrude outward in the radial direction from the second base portion 47. To catch the fixing belt 42, the stoppers 47a and 47b are formed substantially in an L shape when viewed in the width direction (the optical axis direction).

(3) Third Base Portion 50

The third base portion 50 (one example of a base portion) is a belt-shaped portion and links the second grip portion 44 and the third grip portion 45 in the rotation direction. The third base portion 50 is disposed between the second grip portion 44 and the third grip portion 45. The third base portion 50 is shorter than the first base portion 46 and the second base portion 47.

(4) Fourth Base Portion 49

The fourth base portion 49 (one example of a base portion) is a belt-shaped portion, and is linked to the first grip portion 43 in the rotation direction. The fourth base portion 49 protrudes in the rotation direction from the first grip portion 43, and forms a second end of the grip belt 41. The fourth base portion 49 is shorter than the first base portion 46 and the second base portion 47.

(5) First Grip Portion 43

The first grip portion 43 (one example of a grip portion, and an example of a first grip portion) is provided for the user to place his fingers on when turning the zoom ring 31, and forms a substantially belt-shaped portion along with the base portions (the first base portion 46, the second base portion 47, the third base portion 50, and the fourth base portion 49). The first grip portion 43 is linked in the rotation direction to the first base portion 46 and the fourth base portion 49. The first grip portion 43 is disposed between the first base portion 46 and the fourth base portion 49 in the rotation direction, and is formed integrally with the first base portion 46 and the fourth base portion 49. The first grip portion 43 has four first slits 43a, a first anti-slip portion 43b, and a pair of mounting grooves 43e.

The first slits 43a (one example of first slits) are disposed at the radial inner face of the first grip portion 43, and extend in the radial direction. The four first slits 43a are disposed at different positions in the rotation direction, and are disposed substantially equidistantly in the rotation direction. Since the first slits 43a are formed relatively deep in the radial direction, the stiffness of the first grip portion 43 in the rotation direction (and particularly the stiffness of the inner peripheral part of the first grip portion 43) is lowered by the first slits 43a, and the first grip portion 43 becomes stretchable in the rotation direction. In this embodiment, the dimension of the first slits 43a in the radial direction is greater than one-half the dimension M11 of the first grip portion 43 in the radial direction.

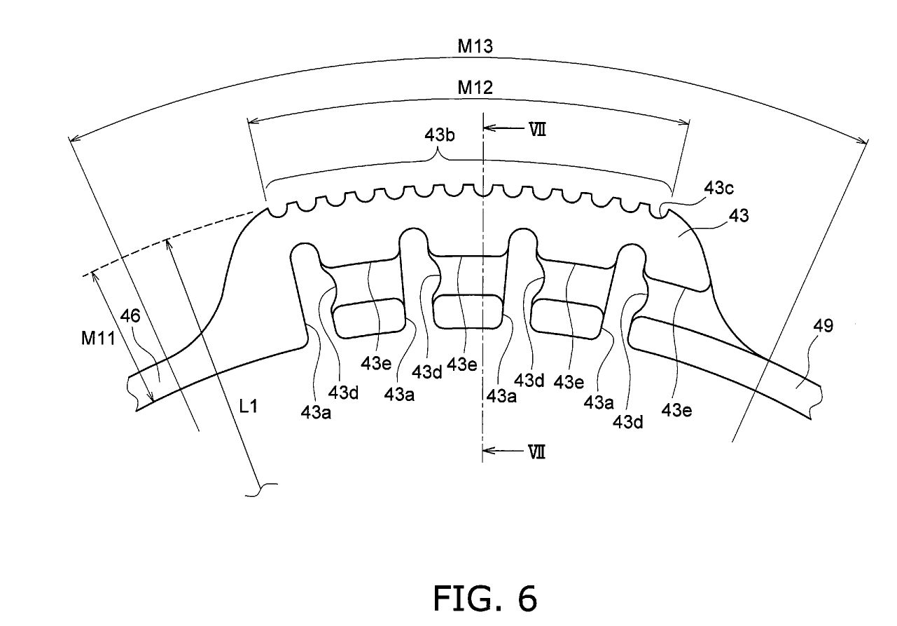

In this embodiment, the ends of the fixing belt 42 are hooked onto the four first slits 43a. More specifically, as shown in FIG. 6, the first slits 43a each have a concave part 43d. The concave parts 43d are provided to prevent insertion parts 42c, 42d, and 42e (discussed below) of the fixing belt 42 from falling out, and have a substantially semicircular shape when viewed in the width direction. The concave parts 43d are disposed at the side walls of the first slits 43a on the fourth base portion 49 side. The positions of the concave parts 43d may be disposed at the side walls of the first slits 43a on the first base portion 46 side, but when the direction in which the fixing belt 42 is hooked is taken into account, it is preferable to dispose the concave parts 43d at the side walls of the first slits 43a on the fourth base portion 49 side (the side walls on the side closer to the stoppers 47a and 47b in the rotation direction).

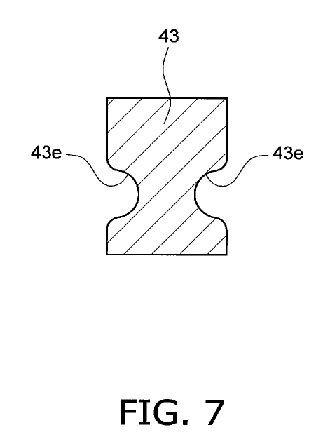

As shown in FIGS. 6 and 7, the mounting grooves 43e are formed so that a pair of coupling portions 42a (discussed below) of the fixing belt 42 can be fitted in, and extend in the rotation direction. The positions of the mounting grooves 43e in the radial direction are substantially the same as the positions of the concave parts 43d in the radial direction. As shown in FIG. 7, the mounting grooves 43e have a substantially semicircular shape when viewed in the rotation direction.

As shown in FIGS. 2A to 6, the first anti-slip portion 43b has a textured shape in which concave and convex parts are repeatedly formed in the rotation direction. More specifically, the first anti-slip portion 43b has a plurality of first grooves 43c disposed equidistantly in the rotation direction. The textured shape is formed by the plurality of first grooves 43c.

(6) Second Grip Portion 44

As shown in FIGS. 2A to 5 and FIG. 8A, the second grip portion 44 (one example of a grip portion, and an example of a second grip portion) is provided for the user to place his fingers on when turning the zoom ring 31, and forms a substantially belt-shaped portion along with the base portions (the first base portion 46, the second base portion 47, the third base portion 50, and the fourth base portion 49). The second grip portion 44 is linked in the rotation direction to the second base portion 47 and the third base portion 50. The first grip portion 43 and the second grip portion 44 are disposed spaced apart in the rotation direction. In this embodiment, the first grip portion 43 and the second grip portion 44 are disposed on opposite sides of the optical axis A. The second grip portion 44 is disposed between the second base portion 47 and the third grip portion 45 in the rotation direction, and is formed integrally with the second base portion 47 and the third base portion 50. The second grip portion 44 has three second slits 44a and a second anti-slip portion 44b.

The second slits 44a (an example of second slits) are disposed at the radial inner face of the second grip portion 44, and extend in the radial direction. The three second slits 44a are disposed at different positions in the rotation direction, and are disposed substantially equidistantly in the rotation direction. Since the second slits 44a are formed relatively deep in the radial direction, the stiffness of the second grip portion 44 in the rotation direction (and particularly the stiffness of the inner peripheral part of the second grip portion 44) is lowered by the second slits 44a, and the second grip portion 44 becomes in the rotation direction. In this embodiment, the dimension of the second slits 44a in the radial direction is greater than one-half the dimension M21 of the second grip portion 44 in the radial direction.

The second anti-slip portion 44b has a textured shape in which concave and convex parts are repeatedly formed in the rotation direction. More specifically, the second anti-slip portion 44b has a plurality of second grooves 44c disposed equidistantly in the rotation direction. The textured shape is formed by the plurality of second grooves 44c.

(7) Third Grip Portion 45

As shown in FIGS. 2A to 5 and FIG. 8B, the third grip portion 45 (one example of a grip portion) is provided for the user to place his fingers on or to grasp with his fingers when turning the zoom ring 31, and is linked to the first base portion 46 and the third base portion 50 in the rotation direction. The third grip portion 45 is disposed between the first base portion 46 and the third base portion 50 in the rotation direction, and is formed integrally with the first base portion 46 and the third base portion 50.

The third grip portion 45 has a third anti-slip portion 45b. The third anti-slip portion 45b has a textured shape in which concave and convex parts are repeatedly formed. More specifically, the third anti-slip portion 45b has a plurality of third grooves 45c disposed equidistantly in the radial direction. The textured shape is formed by the plurality of third grooves 45c.

(8) Rotation Restricting Protrusion

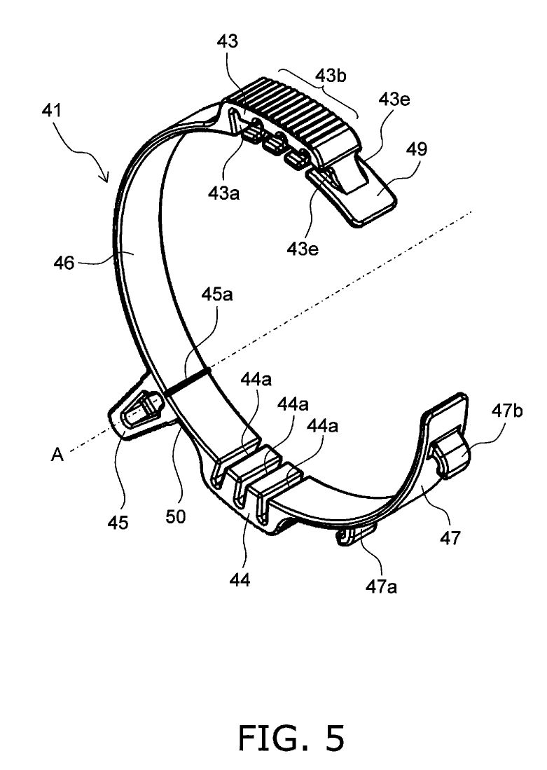

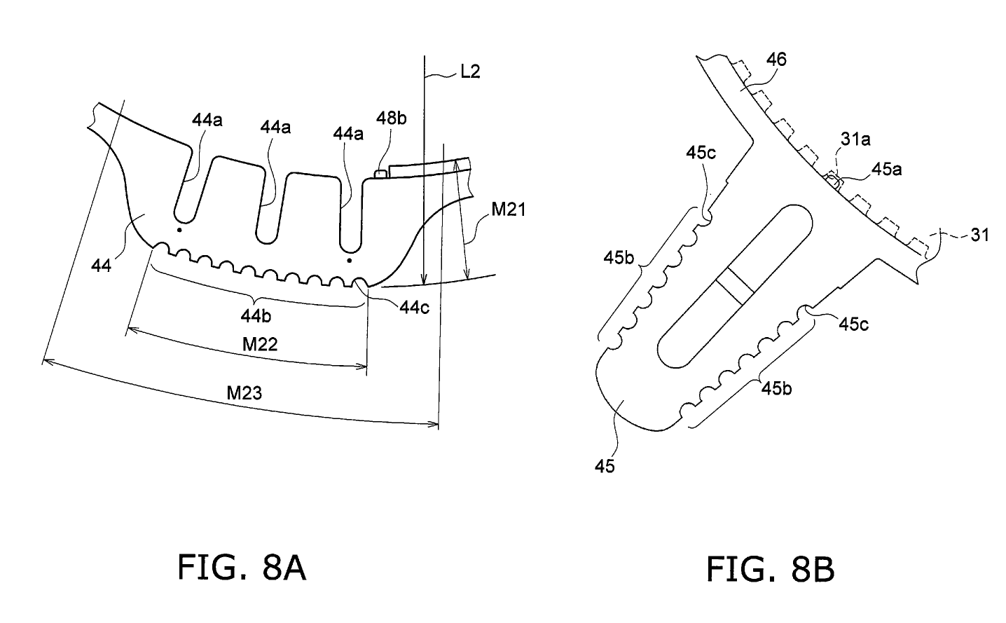

The rotation restricting protrusion 45a is provided to reduce deviation of the grip belt 41 in the rotation direction with respect to the zoom ring 31, and is disposed at the radial inner face of the third grip portion 45. More specifically, as shown in FIG. 8B, the rotation restricting protrusion 45a protrudes inwardly in the radial direction from the radial inner face of the third grip portion 45. As shown in FIG. 5, in this embodiment the rotation restricting protrusion 45a extends in a slender form in the width direction, and has a length that is the same as the width of the third grip portion 45. For example, as shown in FIG. 8B, a plurality of grooves 31a are formed for anti-slip purposes around the outer peripheral face of the zoom ring 31. When the rotation assist assembly 4 is mounted to the zoom ring 31 so that the rotation restricting protrusion 45a fits into one of the grooves 31a, then even if the rotation assist assembly 4 tries to slip in the rotation direction with respect to the zoom ring 31, the rotation restricting protrusion 45a will hit the grooves 31a, which suppresses sliding of the rotation assist assembly 4.

In this embodiment, the rotation restricting protrusion 45a is provided at only one location when viewed in the width direction.

Fixing Belt

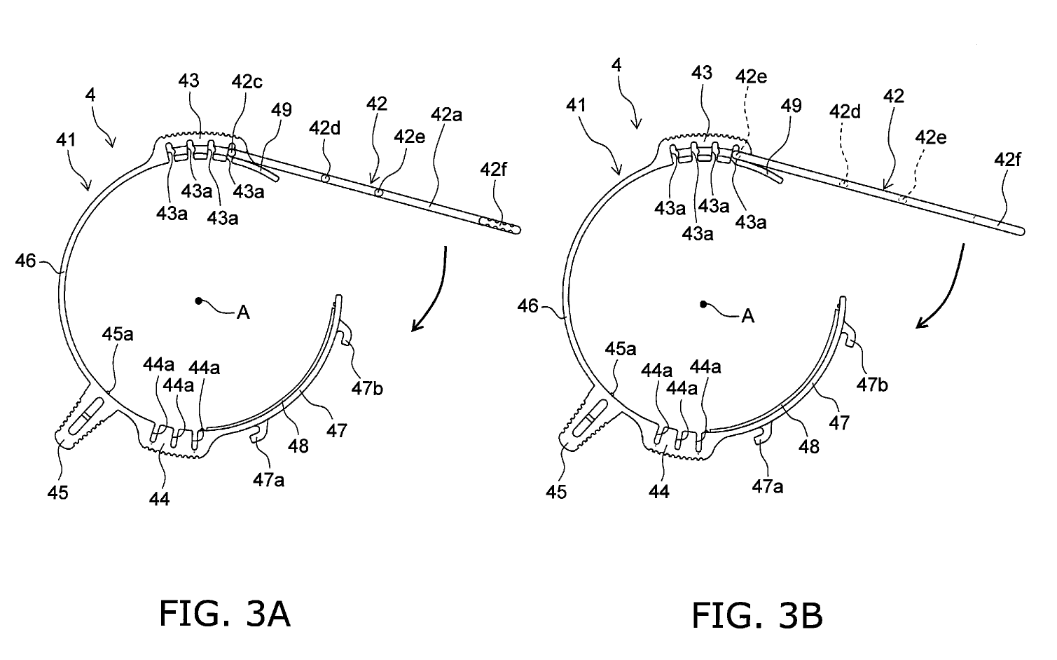

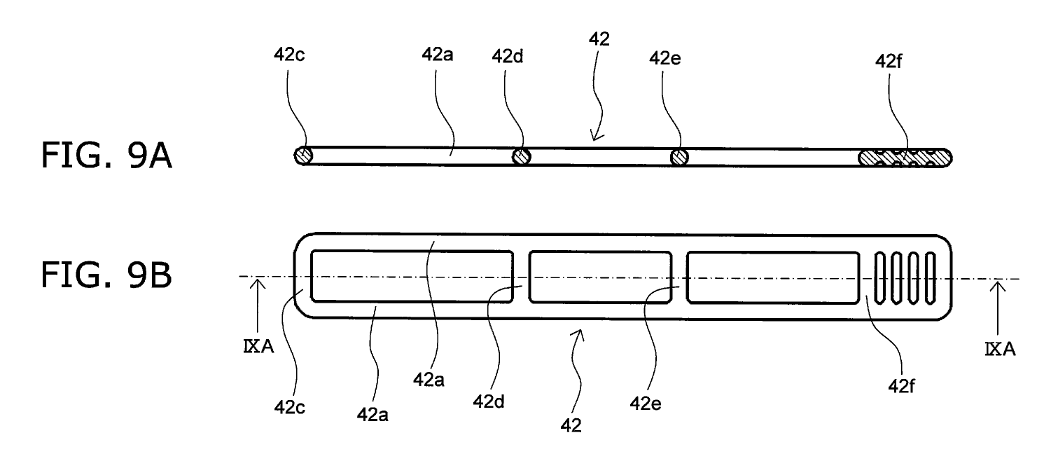

As shown in FIGS. 2A, 3A, and 3B, the fixing belt 42 (one example of a fixing portion) is a member for fastening the grip belt 41 wound around the zoom ring 31, and the whole belt is formed integrally from rubber, for example. In this embodiment, the stiffness of the fixing belt 42 is lower than the stiffness of the material of the grip belt 41. More precisely, the stretchability of the fixing belt 42 allows it to be pulled and extended during mounting. As shown in FIGS. 9A and 9B, the fixing belt 42 has a pair of coupling portions 42a, three insertion parts 42c, 42d, and 42e, and a belt end 42f.

The pair of coupling portions 42a extend in slender form in the rotation direction, and link the three insertion parts 42c, 42d, and 42e and the belt end 42f. The insertion parts 42c, 42d, and 42e (one example of insertion parts) link the pair of coupling portions 42a in the width direction, and are disposed spaced apart in the rotation direction. One of the insertion parts 42c, 42d, and 42e is removably inserted into one of the four first slits 43a.

The belt end 42f (one example of a mounting part) is removably hooked onto the stopper 47a or 47b. The belt end 42f is the portion that the user grasps when hooking the fixing belt 42 onto the stopper 47a or 47b. Because the fixing belt 42 is made of rubber, the belt end 42f can be pulled and the entire fixing belt 42 extended when the belt end 42f is hooked to the stopper 47a or 47b. In a state in which the rotation assist assembly 4 is mounted to the zoom ring 31, the pair of coupling portions 42a is fitted into the pair of mounting grooves 43e.

Felt

As shown in FIG. 2A, the felt 48 is provided to reducing slippage of the rotation assist assembly 4 in the rotation direction with respect to the zoom ring 31, and is fixed on the inside of the grip belt 41 (more precisely, the inside of the second base portion 47). The felt 48 is provided as an assist to the rotation restricting protrusion 45a. The felt 48 is formed of nonwoven fabric, for example. In this embodiment, the dimension of the felt 48 in the rotation direction is substantially the same as the dimension of the second base portion 47 in the rotation direction.

The grip belt 41 has positioning protrusions 48a and 48b so that the felt 48 does not move in the rotation direction with respect to the grip belt 41. The positioning protrusions 48a and 48b are disposed spaced apart in the rotation direction, and the felt 48 is disposed between the positioning protrusions 48a and 48b in the rotation direction. The dimension of the positioning protrusions 48a and 48b in the radial direction is set to be less than the thickness of the felt 48 (the dimension in the radial direction). This prevents the positioning protrusions 48a and 48b from coming into contact with the zoom ring 31. That is, unlike the rotation restricting protrusion 45a, the positioning protrusions 48a and 48b do not themselves have the function of reducing slippage of the grip belt 41 with respect to the zoom ring 31.

Dimensional Relation of Various Components

The dimensional relation between the various components of the grip belt 41 will now be described.

As shown in FIGS. 2A and 6, the first grip portion 43 extends in slender form in the rotation direction, so the dimension M13 of the first grip portion 43 in the rotation direction is greater than the dimension M11 in the radial direction. Also, the dimension M12 of the first anti-slip portion 43b in the rotation direction is greater than the dimension M11. The dimension M13 here is the dimension in the rotation direction from the boundary between the first grip portion 43 and the first base portion 46 to the boundary between the first grip portion 43 and the fourth base portion 49. The first grip portion 43 has a curved part R at its base.

As shown in FIGS. 2A and 8A, just as with the first grip portion 43, the second grip portion 44 extends in slender form in the rotation direction, so the dimension M23 of the second grip portion 44 in the rotation direction is greater than the dimension M21 in the radial direction. Also, the dimension M22 of the second anti-slip portion 44b in the rotation direction is greater than the dimension M21. The dimension M23 here is the dimension in the rotation direction from the boundary between the second grip portion 44 and the third base portion 50 to the boundary between the second grip portion 44 and the second base portion 47. The second grip portion 44 has a curved part R at its base.

Meanwhile, as shown in FIGS. 2A and 8B, unlike with the first grip portion 43 and the second grip portion 44, the third grip portion 45 extends in slender form in the radial direction, so the dimension M33 of the third grip portion 45 in the rotation direction is less than the dimension M31 in the radial direction.

Also, as shown in FIG. 2A, first maximum dimensions (dimensions L1, L2, and L3) from the rotational center of the zoom ring 31 (the optical axis A) to the radial outer faces of the grip portions (the first grip portion 43, the second grip portion 44, and the third grip portion 45) are greater than a second maximum dimension (dimension L0) from the rotational center (optical axis A) to the radial outer faces of the base portions (the first base portion 46, the second base portion 47, the third base portion 50, and the fourth base portion 49). More specifically, the dimension L1 from the optical axis A to the radial outer face of the first grip portion 43 is greater than the dimension L0 from the optical axis A to the radial outer faces of the base portions (the first base portion 46, the second base portion 47, the third base portion 50, and the fourth base portion 49). The dimension L2 from the optical axis A to the radial outer face of the second grip portion 44 is greater than the dimension L0 from the optical axis A to the radial outer faces of the base portions (the first base portion 46, the second base portion 47, the third base portion 50, and the fourth base portion 49). Further, the dimension L3 from the optical axis A to the radial outer face of the third grip portion 45 is greater than the dimension L0 from the optical axis A to the radial outer faces of the base portions (the first base portion 46, the second base portion 47, the third base portion 50, and the fourth base portion 49). Therefore, a relatively large rotational moment can be obtained when the user turns the ring by using the first grip portion 43, the second grip portion 44, and the third grip portion 45.

As shown in FIG. 2A, the dimensions of the grip portions (the first grip portion 43, the second grip portion 44, and the third grip portion 45) in the radial direction (the dimensions M11, M21, and M31) are greater than the dimensions of the base portions (the first base portion 46, the second base portion 47, the third base portion 50, and the fourth base portion 49) in the radial direction (the dimension M0). More specifically, the dimension M11 of the first grip portion 43 in the radial direction is greater than the dimension M0 of the base portions (the first base portion 46, the second base portion 47, the third base portion 50, and the fourth base portion 49) in the radial direction. The dimension M21 of the second grip portion 44 in the radial direction is greater than the dimension M0 of the base portions (the first base portion 46, the second base portion 47, the third base portion 50, and the fourth base portion 49) in the radial direction. The dimension M31 of the third grip portion 45 in the radial direction is greater than the dimension M0 of the base portions (the first base portion 46, the second base portion 47, the third base portion 50, and the fourth base portion 49) in the radial direction. Thus, the first grip portion 43, the second grip portion 44, and the third grip portion 45 protrude outward in the radial direction from the base portions (the first base portion 46, the second base portion 47, the third base portion 50, and the fourth base portion 49), so it is easy for the user to hook his fingers onto these, and since the base portions (the first base portion 46, the second base portion 47, the third base portion 50, and the fourth base portion 49) can be thinner, it is easier to mount the grip belt 41 to the zoom ring 31.

In this embodiment, the dimension M13 of the first grip portion 43 in the rotation direction is greater than the dimension M23 of the second grip portion 44 in the rotation direction. Accordingly, even if the length of the rotary adjustment member around its outer periphery varies, the first grip portion 43 and the second grip portion 44 will be disposed on substantially opposite sides of the rotational center.

Mounting and Removal

The mounting and removal of the rotation assist assembly 4 will now be described.

As shown in FIGS. 3A and 3B, for example, the grip belt 41 is wound around the zoom ring 31 in a state in which the belt end 42f of the fixing belt 42 has been removed from the stoppers 47a and 47b. At this point, since the first grip portion 43 has the first slits 43a, and the second grip portion 44 has the second slits 44a, it is easy to open the grip belt 41 wide.

In winding the grip belt 41 around the zoom ring 31, the position of the grip belt 41 is adjusted so that the rotation restricting protrusion 45a fits into the grooves 31a of the zoom ring 31 (see FIG. 8B). This reduces slippage of the rotation assist assembly 4 in the rotation direction with respect to the zoom ring 31.

After the grip belt 41 has been wound around the zoom ring 31, the belt end 42f of the fixing belt 42 is hooked onto the stoppers 47a or 47b. At this point, one of the stoppers 47a and 47b is selected so that the fixing belt 42 will be stretched out somewhat. Also, the length of the rotation assist assembly 4 in the rotation direction can be adjusted, and the tightness of the rotation assist assembly 4 can be adjusted, by changing in which of the four firsts slit 43a the insertion part 42c is hooked, or by changing which of the insertion parts 42c, 42d, and 42e is hooked in the first slit 43a.

In removing the rotation assist assembly 4 from the zoom ring 31, the belt end 42f is removed from the stopper 47a or 47b while the belt end 42f is pulled. When the fixing belt 42 is removed from the stopper 47a or 47b, the grip belt 41 can be opened wide and removed from the zoom ring 31.

Zooming

When the user performs a zooming operation, he places his fingers on the first grip portion 43 and the second grip portion 44 of the rotation assist assembly 4, and turns the zoom ring 31 and the rotation assist assembly 4. Since the first anti-slip portion 43b and the second anti-slip portion 44b have a textured shape, the fingers do not readily slip. Also, the dimension L1 from the rotational center A to the radial outer face of the first grip portion 43 is greater than the dimension L0 from the rotational center A to the radial outer face of the base portions (the first base portion 46, the second base portion 47, the third base portion 50, and the fourth base portion 49). Accordingly, it is easy to obtain a relatively large rotational moment, and this makes the operation easier.

Also, there may be times when the user grasps the third grip portion 45 with his fingers and turns the zoom ring 31. In this case, since the third grip portion 45 has the pair of third anti-slip portions 45b, the fingers are less likely to slip. Also, since the third grip portion 45 is narrower in the radial direction than the first grip portion 43 and the second grip portion 44, it is easy to obtain a relatively large rotational moment, and the operation is easier.

Features of Rotation Assist Assembly

The features of the rotation assist assembly 4 described above are compiled below.

(1) The dimensions (L1, L2, and L3) from the rotational center A of the zoom ring 31 to the radial outer faces of the grip portions (the first grip portion 43, the second grip portion 44, and the third grip portion 45) are greater than the dimension (L0) from the rotational center A to the radial outer faces of the base portions (the first base portion 46, the second base portion 47, the third base portion 50, and the fourth base portion 49). More specifically, the dimension L1 from the rotational center A to the radial outer face of the first grip portion 43 is greater than the dimension L0 from the rotational center A to the radial outer faces of the base portions (the first base portion 46, the second base portion 47, the third base portion 50, and the fourth base portion 49). The dimension L2 from the rotational center A to the radial outer face of the second grip portion 44 is greater than the dimension L0 from the rotational center A to the radial outer faces of the base portions (the first base portion 46, the second base portion 47, the third base portion 50, and the fourth base portion 49). The dimension L3 from the rotational center A to the radial outer face of the third grip portion 45 is greater than the dimension L0 from the rotational center A to the radial outer faces of the base portions (the first base portion 46, the second base portion 47, the third base portion 50, and the fourth base portion 49). Therefore, when the user places his fingers on the grip portions (the first grip portion 43, the second grip portion 44, and the third grip portion 45) and turns the rotation assist assembly 4, a relatively large rotational moment can be easily obtained, which makes the operation easier.

(2) The dimensions (M11, M21, and M31) of the grip portions (the first grip portion 43, the second grip portion 44, and the third grip portion 45) in the radial direction is greater than the dimension (M0) of the base portions (the first base portion 46, the second base portion 47, the third base portion 50, and the fourth base portion 49) in the radial direction. More specifically, the dimensions M11, M21, and M31 of the first grip portion 43, the second grip portion 44, and the third grip portion 45 in the radial direction are greater than the dimension (M0) of the base portions (the first base portion 46, the second base portion 47, the third base portion 50, and the fourth base portion 49) in the radial direction. Therefore, the above-mentioned dimensions L1, L2, and L3 can be made greater than the dimension L0, while ensuring the required stiffness in the first grip portion 43, the second grip portion 44, and the third grip portion 45.

(3) Since the first grip portion 43 has the four first slits 43a disposed on a radial inner face and extending in the radial direction, the portion of the first grip portion 43 that is on the inside in the radial direction can be stretched in the rotation direction. Consequently, the required stiffness can be ensured in the first grip portion 43, while the grip belt 41 can be opened wide when it is being wound onto the zoom ring 31, which makes it easier to mount the grip belt 41 to the zoom ring 31.

Also, since the second grip portion 44 has the three second slits 44a disposed on a radial inner face and extending in the radial direction, the portion of the second grip portion 44 that is on the inside in the radial direction can be stretched in the rotation direction. Consequently, the required stiffness can be ensured in the second grip portion 44, while the grip belt 41 can be opened wide when it is being wound onto the zoom ring 31, which makes it easier to mount the grip belt 41 to the zoom ring 31.

(4) Since the fixing belt 42 has the insertion parts 42c, 42d, and 42e that are removably inserted into the first slits 43a, the tightness of the rotation assist assembly 4 can be adjusted by adjusting which of the insertion parts 42c, 42d, and 42e is hooked in the first slit 43a.

(5) Since the first grip portion 43 has the plurality of first slits 43a disposed at different positions in the rotation direction, the first grip 43 readily expand and contract in the rotation direction, and the grip belt 41 can be opened wide, and the rotation assist assembly 4 can be easily removed and mounted, when the grip belt 41 is wound onto the zoom ring 31, or when the grip belt 41 is removed from the zoom ring 31. The same applies to the second grip portion 44, since the plurality of second slits 44a are disposed at different positions in the rotation direction.

Also, since the first slits 43a allow the first grip portion 43 to expand and contract easily in the rotation direction, even if the diameter of the zoom ring 31 varies, the grip belt 41 (and particularly the first grip portion 43 and its surrounding part) will readily conform to the outer periphery of the zoom ring 31, and the mounting state of the rotation assist assembly 4 can be stabilized regardless of the diameter of the rotary adjustment member. The same applies to the second grip portion 44.

Furthermore, the tightness of the rotation assist assembly 4 can be fine-tuned by changing the first slit 43a in which the fixing belt 42 is hooked.

That is, the plurality of first slits 43a not only have the function of allowing the rotation assist assembly 4 to conform to the shape of the outer periphery of different rotary adjustment members, but also have the function of adjusting the tightness of the rotation assist assembly 4.

(6) Since the rotation assist assembly 4 has the first grip portion 43 and the second grip portion 44, it is easy for the user to grasp the rotation assist assembly 4 with his fingers, which makes operation easier.

(7) The first grip portion 43 has the first anti-slip portion 43b, which has a textured shape in which concave and convex parts are repeatedly formed in the rotation direction, and the second grip portion 44 has the second anti-slip portion 44b, in which concave and convex parts are repeatedly formed in the rotation direction. Therefore, the fingers do not readily slip when the user operates the rotation assist assembly 4.

(8) Since the second base portion 47 has the stoppers 47a and 47b disposed at different positions in the rotation direction, the tightness of the rotation assist assembly 4 can be adjusted by hooking the fixing belt 42 in one of the stoppers 47a and 47b.

(9) The grip belt 41 has the rotation restricting protrusion 45a, which protrudes inwardly in the radial direction from the radial inner face of the third grip portion 45 so as to be inserted into one of the grooves 31a of the zoom ring 31. When the grip belt 41 is mounted to the zoom ring 31 such that the rotation restricting protrusion 45a is inserted into one of the grooves 31a, if the grip belt 41 should try to slip in the rotation direction with respect to the zoom ring 31, the rotation restricting protrusion 45a will hit the groove 31a, and this reduces slippage of the grip belt 41 in the rotation direction with respect to the zoom ring 31.

Also, since the rotation restricting protrusion 45a is provided at just one location when viewed in the width direction, it can be inserted more easily into the grooves 31a than when the rotation restricting protrusion 45a is provided at a plurality of locations.

### Other Embodiments

The present invention is not limited to the above embodiments, and various changes and modifications are possible without departing from the scope of the invention.

(A) The rotary adjustment member to which the rotation assist assembly 4 is mounted is not limited to the zoom ring 31, and may be a focus ring instead, for example. Also, the lens barrel having the rotary adjustment member is not limited to being an interchangeable lens unit, and may be a lens barrel installed in an integrated type of imaging device.

(B) The rotation assist assembly 4 has the grip belt 41, the fixing belt 42, and the felt 48, but the grip belt 41 and the fixing belt 42 may be formed integrally, for example, and the felt 48 omitted.

Also, the grip portions (the first grip portion 43, the second grip portion 44, and the third grip portion 45) may be separate from the base portions (the first base portion 46, the second base portion 47, the third base portion 50, and the fourth base portion 49).

Further, the grip belt 41 has the first grip portion 43, the second grip portion 44, and the third grip portion 45, but need only have one or more grip portions. Also, the grip belt 41 has the first base portion 46, the second base portion 47, the third base portion 50, and the fourth base portion 49, but need only have one or more grip portions.

The shape and disposition of the first grip portion 43, the second grip portion 44, and the third grip portion 45 are not limited to those in the above embodiment.

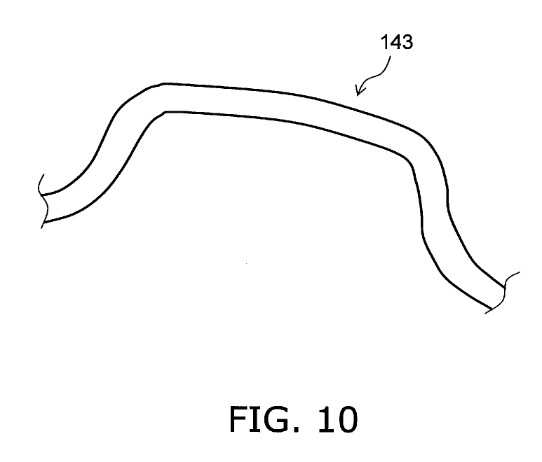

(C) In the above embodiment, the dimensions (M11, M21, and M31) of the grip portions (the first grip portion 43, the second grip portion 44, and the third grip portion 45) in the radial direction is greater than the dimension (M0) of the base portions (the first base portion 46, the second base portion 47, the third base portion 50, and the fourth base portion 49) in the radial direction, but it is also conceivable that the dimensions of the grip portions in the radial direction be the same as the dimension of the base portion in the radial direction, or be less than the dimension in the radial direction. In this case, the first grip portion 43 has a shape like that of the first grip portion 143 shown in FIG. 10, for example.

(D) In the above embodiment, the first grip portion 43 has the four first slits 43a, but the first grip portion 43 need not have the first slits 43a. Also, the second grip portion 44 has the three second slits 44a, but the second grip portion 44 need not have the second slits 44a.

Also, the dimensions of the first slits 43a and the second slits 44a are not limited to those in the above embodiment.

(E) With the above embodiment, the insertion part of the fixing belt 42 is inserted into one of the first slits 43a, but may be inserted into the second slits 44a.

(F) In the above embodiment, the grip portions (the first grip portion 43, the second grip portion 44, and the third grip portion 45) have a textured shape, but need not have a textured shape. Also, the positions and shapes of the second anti-slip portion 44b and the third anti-slip portion 45b are not limited to those in the above embodiments. For example, the first anti-slip portion 43b has a plurality of first grooves 43c, but the textured shape may be formed by something other than grooves.

(G) In the above embodiment, the two stoppers 47a and 47b are provided to the second base portion 47, but there need only been one or more stoppers for hooking the fixing belt 42.

(H) In the above embodiment, the grip belt 41 has the rotation restricting protrusion 45a, but the grip belt 41 need not have the rotation restricting protrusion 45a. Also, the rotation restricting protrusion 45a extends in slender form in the width direction, but need not do so, may be instead be a simple protrusion.

Also, the rotation restricting protrusion 45a may be provided at a plurality of locations, but when insertion into the grooves 31 a is taken into account, it is preferable to provide the rotation restricting protrusion 45a at just one location when viewed in the width direction.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a rotation assist assembly used for a lens barrel. Accordingly, these terms, as utilized to describe the present invention should be interpreted relative to a rotation assist assembly used for a lens barrel.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A rotation assist assembly for assisting the rotation of a rotary adjustment member included in a lens barrel, comprising:
a base portion configured to be wound around the rotary adjustment member along a rotation direction of the rotary adjustment member; and
a grip portion coupled to the base portion in the rotation direction, the grip portion on which a user's finger is placed when rotating the rotary adjustment member,
a first maximum dimension from a rotational center of the rotary adjustment member to an outer face of the grip portion in a radial direction of the rotary adjustment member being greater than a second maximum dimension from the rotational center to a radial outer face of the base portion.

2. The rotation assist assembly according to claim 1, wherein
the dimension of the grip portion in the radial direction is greater than the dimension of the base portion in the radial direction.

3. The rotation assist assembly according to claim 2, wherein
the grip portion includes at least one slit formed on a radial inner face of the grip portion, and
the at least one slit extends in the radial direction.

4. The rotation assist assembly according to claim 3, further comprising
a fixing portion including an insertion part removably inserted into the slit.

5. The rotation assist assembly according to claim 3, wherein
a plurality of the slits are formed on the radial inner face of the grip portion and disposed at different positions from each other in the rotation direction.

6. The rotation assist assembly according to claim 1, wherein
the grip portion includes a first grip portion and a second grip portion, and
the first and second grip portions are disposed spaced apart in the rotation direction and are disposed sandwiching at least part of the base portion in the rotation direction.

7. The rotation assist assembly according to claim 1, wherein
the grip portion has a textured shape in which concave and convex parts are repeatedly formed in the rotation direction and are disposed on a radial outer face.

8. The rotation assist assembly according to claim 4, wherein
the base portion further includes one or more stoppers disposed at different positions from each other in the rotation direction, and
the fixing portion further includes a mounting part mountably arranged with respect to the one or more stoppers.

9. The rotation assist assembly according to claim 1, further comprising
one or more rotation restricting protrusions protruding inwardly in the radial direction from at least one of the radial inner face of the grip portion and the radial inner face of the base portion so as to be inserted into a concave part formed on a radial outer face of the rotary adjustment member.

10. The rotation assist assembly according to claim 9, wherein
the rotation restricting protrusion is arranged at just one location when viewed in a width direction perpendicular to the radial direction and the rotational direction.

11. The rotation assist assembly according to claim 4, wherein
a plurality of the slits are formed on the radial inner face of the grip portion and are disposed at different positions from each other in the rotation direction.

12. The rotation assist assembly according to claim 2, wherein
the grip portion includes a first grip portion and a second grip portion, and
the first and second grip portions are disposed spaced apart in the rotation direction and are disposed sandwiching at least part of the base portion in the rotation direction.

13. The rotation assist assembly according to claim 2, wherein
the grip portion has a textured shape in which concave and convex parts are repeatedly formed in the rotation direction and are disposed on a radial outer face.

14. The rotation assist assembly according to claim 5, wherein
the base portion further includes one or more stoppers disposed at different positions from each other in the rotation direction, and
the fixing portion further includes a mounting part mountably arranged with respect to the one or more stoppers.

15. The rotation assist assembly according to claim 2, further comprising
one or more rotation restricting protrusions protruding inwardly in the radial direction from at least one of the radial inner face of the grip portion and the radial inner face of the base portion so as to be inserted into a concave part formed on a radial outer face of the rotary adjustment member.

16. The rotation assist assembly according to claim 15, wherein
the rotation restricting protrusion is arranged at just one location when viewed in a width direction perpendicular to the radial direction and the rotational direction.

17. The rotation assist assembly according to claim 3, wherein
the grip portion includes a first grip portion and a second grip portion, and
the first and second grip portions are disposed spaced apart in the rotation direction and are disposed sandwiching at least part of the base portion in the rotation direction.

18. The rotation assist assembly according to claim 3, wherein
the grip portion has a textured shape in which concave and convex parts are repeatedly formed in the rotation direction and are disposed on a radial outer face.

19. The rotation assist assembly according to claim 11, wherein
the base portion further includes one or more stoppers disposed at different positions from each other in the rotation direction, and
the fixing portion further includes a mounting part mountably arranged with respect to the one or more stoppers.

20. The rotation assist assembly according to claim 3, further comprising
one or more rotation restricting protrusions protruding inwardly in the radial direction from at least one of the radial inner face of the grip portion and the radial inner face of the base portion so as to be inserted into a concave part formed on a radial outer face of the rotary adjustment member.
